(19) United States
(12) Patent Application Publication
(10) Pub. No.: US 2026/0210502 A1
(43) Pub. Date: Jul. 23, 2026

(54) ANTIROTATION DEVICE FOR COMPRESSED GAS CYLINDERS

(71) Applicant: VERSUM MATERIALS US, LLC, Tempe, AZ (US)

(72) Inventors: James Dougher, Schnecksville, PA (US); Richard Tetley, Wyomissing, PA (US); Joy Racowski, Archbald, PA (US); James Nehlsen, Emmaus, PA (US)

(21) Appl. No.: 19/140,602

(22) PCT Filed: Dec. 20, 2023
(86) PCT No.: PCT/US2023/084997

§ 371 Date: Jun. 18, 2025

Related U.S. Application Data
(60) Provisional application No. 63/476,678, filed on Dec. 22, 2022.

(51) Int. Cl. F17C 13/08; F17C 5/06

(52) U.S. Cl. CPC F17C 13/084; F17C 5/06; F17C 2201/0109; F17C 2201/035; F17C 2205/0192

(57) ABSTRACT

An antirotation assembly (100) including a skid (110) having a bracket (140) disposed on a top surface (112), and an antirotation device (200)having an elongate body (210), a first end (220) and a second end (230). The first end (220) is removably securable to an opening (144) of the bracket (140), and the second end (230) removably securable to a neck (188) of a cylinder (180). A locked state is defined by the first end (220) of the antirotation device (200) fastened to the bracket (140), and an unlocked state is defined by the first end (220) of the antirotation device (200) not fastened to the bracket (140). The antirotation device (200) is rotatable about a longitudinal axis Y defined by the neck (188) of the cylinder (180) in the unlocked state.

### BACKGROUND

The field of the disclosure relates generally to securement devices for compressed gas cylinders, and more particularly, to an antirotation device utilized while transporting compressed gas cylinders.

Compressed gas cylinders are used for storing liquified gasses under pressure. The cylinders are commonly filled at a service station and transported to an end user. To transport cylinders safely, the cylinders have to be secured to a skid which limits rolling and sliding of the cylinder. Cylinders are conventionally secured with straps or by securing ends of the cylinder to the skid. These methods however do not permit temporary rotation of the cylinder in order to adjust the orientation of the cylinder such that a user can access a pressure relief valve or a nozzle of the cylinder and for filling.

Accordingly, there is a need in the art to provide an apparatus for securing a compressed gas cylinder to a skid and to permit access to pressure relief valves or nozzles of the compressed gas cylinders.

### BRIEF DESCRIPTION

In one aspect, an antirotation assembly for compressed gas cylinders is disclosed. The antirotation assembly includes antirotation assembly includes a skid having a top surface; a bracket disposed on the top surface of the skid, the bracket having an opening; and an antirotation device having an elongate body, a first end and a second end, the first end removably securable to the opening of the bracket, the second end removably securable to a neck of a cylinder. A locked state of the antirotation device is defined by the first end of the antirotation device fastened to the bracket, and an unlocked state of the antirotation device is defined by the first end of the antirotation device not fastened to the bracket. The antirotation device is rotatable about a longitudinal axis defined by the neck of the cylinder in the unlocked state. An attached state of the antirotation device is defined by the second end attached to the neck of the cylinder, and an unattached state of the antirotation device is defined by the second end unattached to the neck of the cylinder.

In another aspect, a method of securing a cylinder to a skid is disclosed. The method includes positioning a cylinder on a top surface of the skid, the cylinder having a neck; positioning a second end of an antirotation device onto the neck of the cylinder; attaching the antirotation device to the neck of the cylinder, defining an attached state of the antirotation device; positioning the first end of the antirotation device against a longitudinal sidewall of a bracket of the skid, the bracket disposed on the top surface of the skid; and, fastening the first end of the antirotation device to the bracket, defining a locked state of the antirotation device such that the cylinder is removably secured to the skid. An unlocked state of the antirotation device is defined by the first end of the antirotation device not fastened to the bracket, and wherein an unattached state of the antirotation device is defined by the second end unattached to the neck of the cylinder.

In yet another aspect, a method of filling a cylinder secured to a skid is disclosed. The method includes positioning a cylinder on a top surface of the skid, the cylinder having a neck and a fill valve, and the fill valve having a fill port; attaching a second end of an antirotation device onto the neck of the cylinder, defining an attached state of the antirotation device; positioning a first end of the antirotation device against a longitudinal sidewall of a bracket of the skid, the bracket disposed on the top surface of the skid defining a first angular position, wherein unlocked state of the antirotation device is defined by the first end of the antirotation device not fastened to the bracket; rotating the cylinder and the antirotation device along a longitudinal axis defined by the neck of the cylinder to a second angular position such that the fill valve is accessible; filling the cylinder through the fill port of the fill valve; rotating the cylinder and the antirotation device to the first angular position; and, fastening the first end of the antirotation device to the bracket defining a locked state of the antirotation device.

These and other aspects and features of the present disclosure will be more readily understood when read in conjunction with the accompanying drawings.

### BRIEF DESCRIPTION OF THE DRAWINGS

FIG. 1 illustrates a perspective view of an antirotation assembly for compressed gas cylinders in accordance with embodiments of the present disclosure;

FIG. 2 illustrates a partial view of DETAIL A of the antirotation assembly of FIG. 1;

FIG. 3 illustrates a side elevation view of the antirotation assembly of FIG. 1;

FIG. 4 illustrates partial view of DETAIL B of the antirotation assembly of FIG. 3;

FIG. 5 illustrates a front plan view of the antirotation assembly of FIG. 1;

FIG. 6 illustrates a front plan view of an antirotation device of the antirotation assembly of FIG. 1;

FIG. 7 illustrates a side elevation view of the antirotation device of FIG. 6;

FIG. 8 illustrates a method of securing a cylinder to a skid; and,

FIG. 9 illustrates a method of filling a cylinder secured to a skid.

The reference symbols used in the drawings, and their meanings, are listed in summary form in the list of reference symbols. In principle, identical parts are provided with the same reference symbols in the figures.

### DETAILED DESCRIPTION

In the following specification and the claims, reference will be made to a number of terms, which shall be defined to have the following meanings.

As used herein, the singular forms “a,” “an,” and “the” include plural references unless the context clearly dictates otherwise. The terms “comprising,” “including,” and “having” are intended to be inclusive and mean that there may be additional elements other than the listed elements. The terms “optional” or “optionally” means that the subsequently described event or circumstance may or may not occur, and that the description includes instances where the event occurs and instances where it does not.

Embodiments of the present disclosure are directed to an antirotation assembly. The antirotation assembly includes a skid having a top surface; a bracket disposed on the top surface of the skid, the bracket having a longitudinal opening; and, an antirotation device having an elongate body, a first end and a second end, the first end removably securable to the longitudinal opening of the bracket, the second end removably securable to a neck of a cylinder. The antirotation device is fastened to the bracket defining a locked state, and the antirotation device is rotatable about the neck of the cylinder in an unlocked state where the antirotation device is not fastened to the bracket.

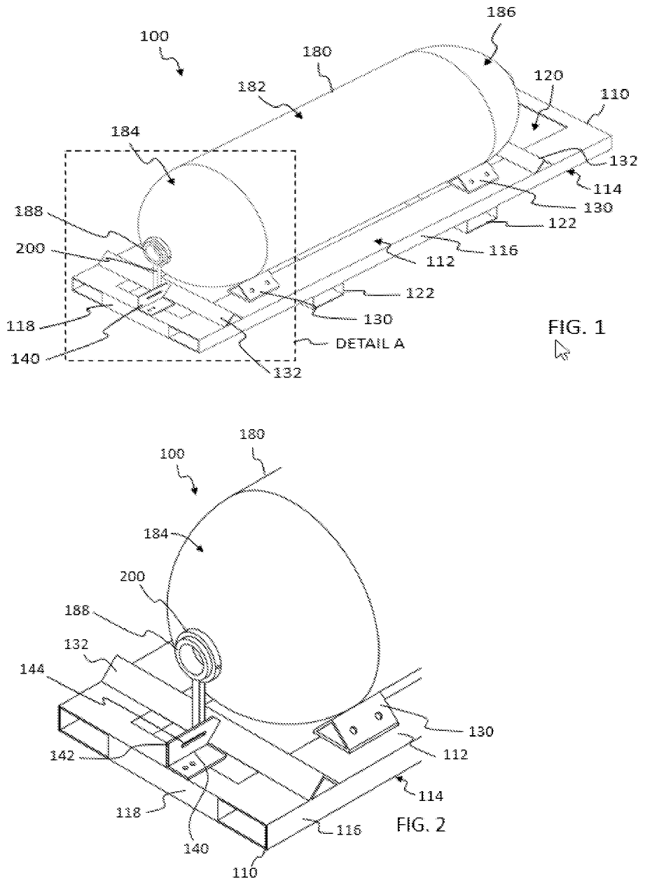

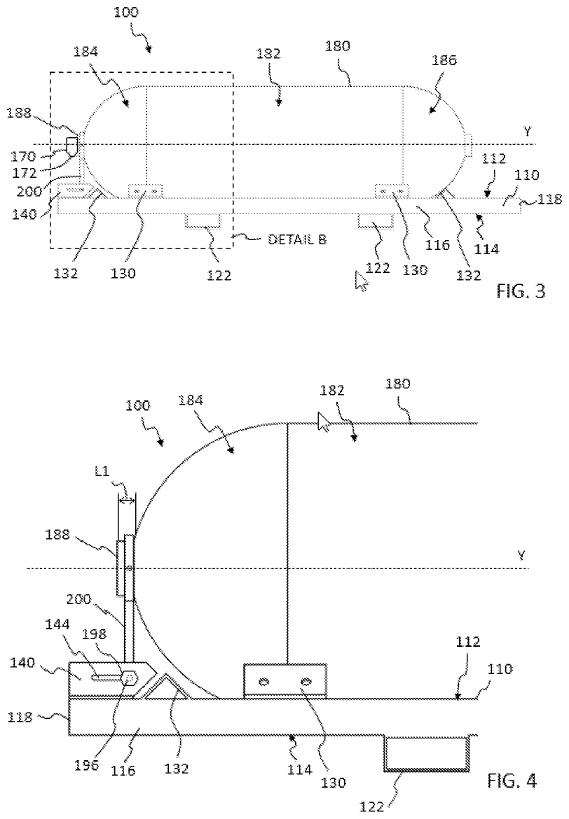

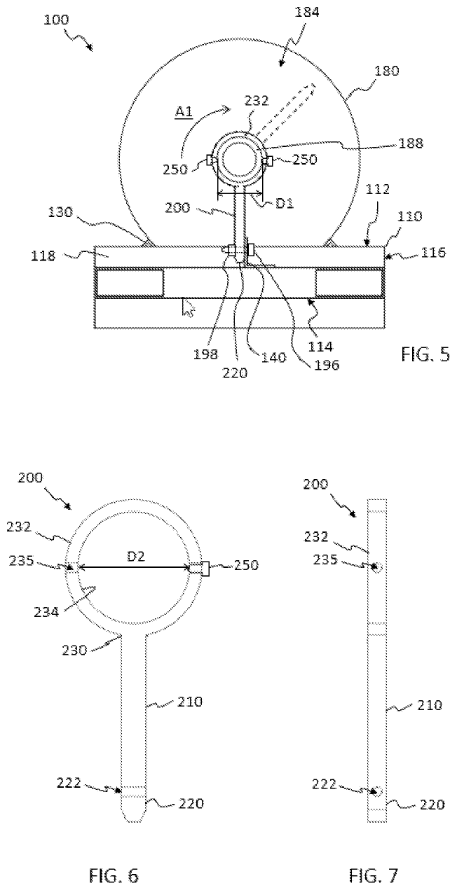

Various aspects of the disclosure will now be described with reference to the drawings disclosed herein, wherein like reference numbers refer to like elements, unless specified otherwise. FIG. 1 illustrates a perspective view of an antirotation assembly 100, with FIG. 2 illustrating an enlarged partial view of Detail A of FIG. 1. FIG. 3 illustrates a side elevation view of the antirotation assembly 100, with FIG. 4 illustrating a partial view of Detail B of FIG. 3. FIG. 5 illustrates a front plan view of the antirotation assembly 100.

Referring generally to FIGS. 1-5, the antirotation assembly 100 comprises a skid 110 having a top surface 112 and a bottom surface 114 and is configured to secure a cylinder 180. The skid 110 has a generally rectangular shape having a longitudinal edge 116 and a lateral edge 118, with the cylinder 180 positioned on the top surface 112 and extending parallel to the longitudinal edge 116. In some embodiments, the skid 110 includes an opening 120 through which at least a portion of the cylinder 180 is positioned. In some embodiments, the skid 110 further includes forklift receivers 122 extending traverse to the longitudinal edge 116. The forklift receivers 122 are structural tubes which also provide structural support to the skid 110. In the illustrated embodiment, each skid 110 is configured to secure one cylinder 180, however in some embodiments, skids 110 be positioned adjacent to one another or skids 110 can be stacked onto one another with additional vertical lateral supports connecting multiple skids 110.

The cylinder 180 comprises a cylindrical center portion 182, front dome-shaped portion 184 and a rear dome-shaped portion 186. In some embodiments, the rear portion is flat. As best shown in FIG. 3, the front dome-shaped portion 184 and a rear dome-shaped portion 186 define a central axis Y of the cylinder 180. Referring back to FIGS. 1-5, the front dome-shaped portion 184 includes a cylindrical neck 188 extending from the front dome-shaped portion 184. As best shown in FIG. 4, the cylindrical neck 188 is concentric with the central axis Y of the cylinder 180 and the cylindrical neck 188 extends a length L1 from the front dome-shaped portion 184. Turning now to FIG. 5, the cylindrical neck 188 has an outer diameter D1. As explained in further detail below, an end of the antirotation device 200 is configured to surround the cylindrical neck 188 of the cylinder 180 to help secure the cylinder 180 to the skid 110. In a preferred embodiment the rear dome-shaped portion 186 lacks any mechanical means configured to help removably secure the cylinder 180 to the skid 110. For example, the rear dome-shaped portion 186 may be free of pin holes, threaded taps, or the like, that may be used as a part of a means to removably secure the cylinder 180 to the skid 110.

Referring to FIGS. 1-5, the antirotation assembly 100 further includes longitudinal guides 130 extending along the top surface 112 of the skid 110. The longitudinal guides 130 contact the cylindrical center portion 182 of the cylinder 180 to prevent rolling of the cylinder 180. As the cylinder 180 is positioned at least partially within the opening 120, the cylinder 180 is seated against the longitudinal guides 130. The antirotation assembly 100 further includes further includes lateral stops 132 extending across the top surface 112 of the skid 110. The lateral stops 132 mitigate or prevent longitudinal movement of the cylinder 180.

As best shown in FIGS. 2 and 4, the antirotation assembly 100 further includes a bracket 140 disposed on the top surface 112 of the skid 110. The bracket 140 includes a longitudinal sidewall 142 having a longitudinal opening 144. In some embodiments, the longitudinal opening 144 is circular. In some embodiments, the longitudinal opening 144 is a longitudinal slot. As explained in further detail below, the longitudinal opening 144 is configured to receive a fastener 196.

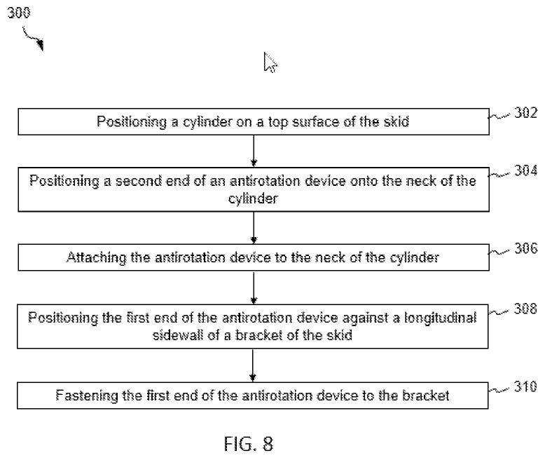

FIG. 6 illustrates a front plan view of an antirotation device 200 for removably securing the cylinder 180 to the skid 110, and FIG. 7 illustrates a side elevation view of the antirotation device 200. The antirotation device 200 includes an elongate body 210 having a first end 220 and a second end 230 having a circular ring 232. The first end 220 includes an aperture 222 extending through the first end 220. As best shown in FIGS. 4 and 5, the first end 220 is removably securable to the longitudinal opening 144 of the bracket 140 by passing the fastener 196 through the aperture 222 of the first end 220 and the longitudinal opening 144 of the bracket 140. The fastener 196 can be secured by a nut 198. In some embodiments, the aperture 222 has threads which threadedly secure with the fastener 196. In embodiments where the longitudinal opening 144 of the bracket 140 is a slot, the antirotation device 200 can be secured to the bracket 140 at any point along the slot. Stated differently, the first end 220 of the antirotation device 200 is translatable along the longitudinal slot of the bracket in an unlocked state of the antirotation device 200 to properly position the cylinder 180 on the skid 110. The unlocked state is defined by the antirotation device 200 not fastened or secured to the bracket 140, and a locked state is defined by the antirotation device 200 being fastened or secured to the bracket 140.

Referring back to FIGS. 6 and 7, the circular ring 232 has an inner surface 234 defining an inner diameter D2 of the circular ring 232. The inner surface 234 is configured to surround the cylindrical neck 188 of the cylinder 180 (as best shown in FIG. 5). In some embodiments, the inner diameter D2 of the circular ring 232 is sized and configured to create an interference fit with the outer diameter D1 of the cylindrical neck 188 and the inner surface 234, thus removably securing the antirotation device 200 to the cylinder 180. In some embodiments, the circular ring 232 includes at least one set screw 250 threaded into at least one aperture 235 extending through the circular ring 232. Advancement of the at least one set screw 250 against the cylindrical neck 188 of the cylinder 180 may removably secure the cylindrical neck 188 of the cylinder 180 to the circular ring 232 and so to the antirotation device 200. The at least one set screw 250 may secure the cylindrical neck 188 with an interference fit.

An attached state of the antirotation device 200 is defined by the second end 230 (and more particularly the circular ring 232) attached to the neck 188 of the cylinder 180, and an unattached state of the antirotation device 200 is defined by the second end 230 unattached to the neck 188 of the cylinder 180. The above is true regardless of whether antirotation device 200 is removably secured to the cylindrical neck 188 by an interference fit between the inner surface 234 and the cylindrical neck 188, or by the use of the at least one set screw 250.

In operation, the cylinder 180 is positioned on the skid 110 such that the cylindrical neck 188 of the cylinder 180 is aligned with the bracket 140 of the skid 110. The antirotation device 200 is then removably secured to the cylindrical neck 188 of the cylinder 180 in the attached state. As shown in FIG. 5, the cylinder 180 may be rotated in a first angular direction Al about the longitudinal axis Y. In the attached state and in the unlocked state, the cylinder 180 and antirotation device 200 are together rotatable from a first angular position to a second angular position. In the first angular position (shown in FIG. 5), the antirotation device 200 abuts the bracket 140 of the skid 110. In the second angular position (shown by dashed lines in FIG. 5), the antirotation device 200 and the cylinder 180 are rotated about the central axis Y of the cylinder 180.

Turing back to FIG. 3, in some embodiments the cylindrical neck 188 includes a fill valve 170 having a fill port 172 directed downward toward the skid 110 in the locked state. It is common to have the fill port 172 directed downward toward the skid 110 and in the locked state for transportation of the skid 110 and cylinder 180. Furthermore, the cylinder 180 cannot be refilled when the fill port 172 is directed downward toward the skid 110. Thus, to fill or refill the cylinder 180 when the cylinder 180 is on the skid 110, the antirotation device 200 can be unfastened in the unlocked state and the cylinder 180 with the antirotation device 200 is rotated to the second angular position to fill the cylinder 180. The process can then be reversed and the antirotation device 200 can be fastened in the locked state. In some embodiments, the second angular position up to 180 degrees from the first angular position.

### INDUSTRIAL APPLICABILITY

In operation, the teachings of the present disclosure can find applicability in many industrial applications, such as, but not limited to, allowing for temporary rotation of the cylinder 180, or more generally, to alter the orientation of the cylinder such that a user can access a pressure relief valve or the fill port 172 of the cylinder 180. The present disclosure allows for refilling a cylinder 180 already positioned on a skid 110, enabling quicker refilling. The cylinder 180 is rotatable up to 180 degrees while still resting on the skid 110 (and thus not having to remove the cylinder from the skid 110 for refilling) by simply unlocking the first end 220 of the antirotation device 200 from the bracket 140 of the skid 110. Because the antirotation device 200 remains attached to the cylinder 180 in the attached state, even while refilling, to lock the antirotation device 220 (and cylinder 180) back onto the skid 110, the user has to merely rotate the antirotation device 220 (and cylinder 180) in the opposite direction and fasten the antirotation device 220 to the skid 110.

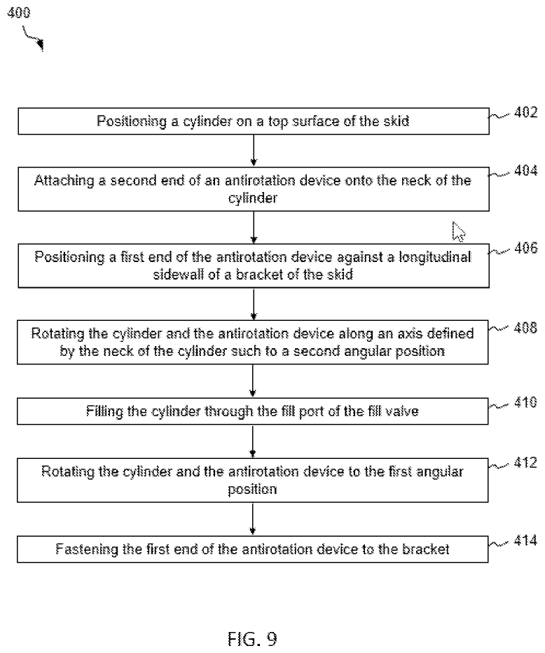

A method 300 of securing a cylinder 180 is shown in FIG. 8. The method 300 comprises positioning 302 the cylinder 180 on a top surface 112 of a skid 110, the cylinder 180 having a cylindrical neck 188; positioning 304 a second end 232 of an antirotation device 200 onto the cylindrical neck 188 of the cylinder; attaching 306 the antirotation device 200 to the cylindrical neck 188 of the cylinder 180; positioning 308 the first end 230 of the antirotation device 200 against a longitudinal sidewall 142 of a bracket 140 of the skid 110; and, fastening 310 the first end 230 of the antirotation device 200 to the bracket 140, thereby defining a first locked state of the antirotation device 200.

A method of filling a cylinder 180 secured to a skid 110 is shown in FIG. 9. The method 400 comprises positioning 402 the cylinder 180 on a top surface 112 of the skid 110, the cylinder 180 having a cylindrical neck 188 and a fill valve 170. The method 400 further comprises attaching 404 a second end 232 of an antirotation device 200 onto the cylindrical neck 188 of the cylinder 180, positioning 406 a first end 230 of the antirotation device 200 against a longitudinal sidewall 142 of a bracket 140 of the skid 110, rotating 408 the cylinder 180 and the antirotation device 200 along a longitudinal axis Y defined by the cylindrical neck 188 of the cylinder 180 from a first angular position to a second angular position, and connecting the filling port 172 to a gas source, and filling 410 the cylinder 180 through the fill port of the fill valve. After filling the cylinder 180, the method 400 further comprises rotating 412 the cylinder 180 and the antirotation device 200 back to the first angular position, and fastening 414 the first end 230 of the antirotation device 200 to the bracket 140.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the present system and methods have been described in terms of various specific embodiments, those skilled in the art will recognize that the subject technology can be practiced with modification within the spirit and scope of the claims.

1. An antirotation assembly comprising:
a skid having a top surface;
a bracket disposed on the top surface of the skid, the bracket having an opening; and
an antirotation device having an elongate body, a first end and a second end, the first end removably securable to the opening of the bracket, the second end removably securable to a neck of a cylinder;
wherein a locked state of the antirotation device is defined by the first end of the antirotation device fastened to the bracket, and an unlocked state of the antirotation device is defined by the first end of the antirotation device not fastened to the bracket wherein the antirotation device is rotatable about a longitudinal axis Y defined by the neck of the cylinder in the unlocked state.

2. The antirotation assembly of claim 1, wherein an attached state of the antirotation device is defined by the second end attached to the neck of the cylinder, and an unattached state of the antirotation device is defined by the second end unattached to the neck of the cylinder.

3. The antirotation assembly of claim 2, wherein the antirotation device and the cylinder are together rotatable about the longitudinal axis in the unlocked state and the attached state.

4. The antirotation assembly of claim 1, wherein the opening of the bracket is a longitudinal slot.

5. The antirotation assembly of claim 4, wherein the first end of the antirotation device is translatable along the longitudinal slot of the bracket.

6. The antirotation assembly of claim 1, wherein the second end includes a circular ring having an inner surface configured to surround the neck of the cylinder.

7. The antirotation assembly of claim 6, wherein the neck of the cylinder is removably secured to the circular ring by an interference fit.

8. The antirotation assembly of claim 6, wherein the circular ring further includes a set screw.

9. The antirotation assembly of claim 8, wherein advancement of the set screw against the neck of the cylinder removably secures the neck of the cylinder to the circular ring.

10. The antirotation assembly of claim 9, wherein the set screw secures the neck of the cylinder with an interference fit.

11. The antirotation assembly of claim 1, wherein the cylinder and the antirotation device are rotatable from a first angular position to a second angular position in the unlocked state, and wherein the first angular position is defined by the antirotation device abutting the bracket.

12. The antirotation assembly of claim 11, wherein the second angular position is up to 180 degrees from the first angular position.

13. The antirotation assembly of claim 1, wherein the skid further includes longitudinal guides extending along the surface of the skid.

14. The antirotation assembly of claim 13, wherein the longitudinal guides prevent rolling of the cylinder.

15. The antirotation assembly of claim 1, wherein the skid further includes lateral stops extending across the surface of the skid.

16. The antirotation assembly of claim 15, wherein the lateral stops prevent longitudinal movement of the cylinder.

17. The antirotation assembly of claim 1, wherein the cylinder further includes a rear dome-shaped portion lacking mechanical means configured to removably secure the cylinder to the skid.

18. The antirotation assembly of claim 17, wherein the mechanical is selected from the group consisting of a pinhole and a threaded tap.

19. A method of securing a cylinder to a skid comprising:
positioning a cylinder on a top surface of the skid, the cylinder having a neck;
positioning a second end of an antirotation device onto the neck of the cylinder;
attaching the antirotation device to the neck of the cylinder, defining an attached state of the antirotation device;
positioning the first end of the antirotation device against a longitudinal sidewall of a bracket of the skid, the bracket disposed on the top surface of the skid; and,
fastening the first end of the antirotation device to the bracket, defining a locked state of the antirotation device such that the cylinder is removably secured to the skid.

20. The method of claim 19, wherein an unlocked state of the antirotation device is defined by the first end of the antirotation device not fastened to the bracket, and wherein an unattached state of the antirotation device is defined by the second end unattached to the neck of the cylinder.

21. The method of claim 19, wherein the antirotation device and the cylinder are together rotatable about the longitudinal axis Y in the unlocked state and the attached state.

22. A method of filling a cylinder secured to a skid comprising:
positioning a cylinder on a top surface of the skid, the cylinder having a neck and a fill valve and the fill valve having a fill port;
attaching a second end of an antirotation device onto the neck of the cylinder, defining an attached state of the antirotation device;
positioning a first end of the antirotation device against a longitudinal sidewall of a bracket of the skid, the bracket disposed on the top surface of the skid defining a first angular position, wherein unlocked state of the antirotation device is defined by the first end of the antirotation device not fastened to the bracket;
rotating the cylinder and the antirotation device along a longitudinal axis Y defined by the neck of the cylinder to a second angular position such that the fill valve is accessible;
filling the cylinder through the fill port of the fill valve;
rotating the cylinder and the antirotation device the first angular position; and,
fastening the first end of the antirotation device to the bracket defining a locked state of the antirotation device.
